(19) United States
(12) Patent Application Publication
(10) Pub. No.: US 2007/0007754 A1
(43) Pub. Date: Jan. 11, 2007

(54) Air bag chute

(76) Inventors: Anthony V. Rybinski, Walled Lake, MI (US); Ilaria Accorsi, Royal Oak, MI (US); Andrew Kuzdak III, Rochester Hills, MI (US); William M. Snell, Grand Blanc, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/178,968

(22) Filed: Jul. 11, 2005

(51) Int. Cl. B60R 21/20

(52) U.S. Cl. 280/728.3; 280/732

(57) ABSTRACT

A chute for receipt of a deploying air bag includes a compartment having first and second sidewalls extending laterally outwardly from a rear bag receiving aperture toward a front cover panel. The expanding volume of the chute enables a deploying air bag to outwardly expand at least partially parallel to a frangible seam in the front cover panel before the bag contacts the seam and ruptures it. As a result, the force of the bag is dispersed evenly along the seam to reduce maximum bag force exerted against the portion of the front cover panel located directly in front, or in the center, of the bag.

### FIELD OF THE INVENTION

The present invention relates to vehicle safety systems employing air bags and more particularly to an air bag chute for an air bag.

### BACKGROUND OF THE INVENTION

In known air bag deployment arrangements, deployable outer doors of an air bag housing are separated by at least one tearable seam, against which a deploying air bag exerts a force when the bag is inflating. The expanding bag exerts force only on a portion of the seam centrally located with respect to the bag's leading surface.

There is a need for an air bag deployment arrangement which will allow the air bag to exert pressure substantially evenly along the entire extent of the tearable seam, thereby reducing maximum force from being exerted only against a portion of the air bag door located centrally in front of the deploying air bag.

### SUMMARY OF THE INVENTION

An air bag chute has a compartment having a front cover panel including at least one frangible seam therein, a rear aperture opposite the front cover panel adapted to receive a deploying air bag, and first and second walls extending between the rear aperture and the front cover panel, at least one of the walls extending laterally outwardly from the rear aperture towards the front cover panel, whereby the compartment is adapted to enable a deploying air bag to expand at least partially parallel to the frangible seam before contacting the front cover panel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle with an instrument panel including an air bag safety system employing an air bag chute with an air bag according to the principles of the present invention;

FIG. 2 is cross sectional view of the air bag safety system of FIG. 1 taken along line 2-2 of FIG. 1;

FIG. 2A is a detailed cross sectional view of the air bag safety system of FIG. 1;

FIG. 3 is a rear view of the air bag safety system of FIG. 1;

FIG. 4A is an environmental view of the air bag safety system of FIG. 1 during the expansion of the air bag; and

FIG. 4B is top view of an occupant contacting the air bag after the air bag has fully expanded from the air bag safety system of FIG. 1.

### DETAILED DESCRIPTION

The following description is merely exemplary in nature and is in no way intended to limit the invention, its application, or uses.

The present invention is generally related to an air bag chute for use with a safety system disposed in a motor vehicle. Although the following exemplary description refers to the use of an air bag chute disposed in an instrument panel of a motor vehicle, it will be understood that the present invention may be applicable to other types of air bag safety systems, and to different locations within the vehicle. Further, the foregoing description is understood to not limit the appended claims.

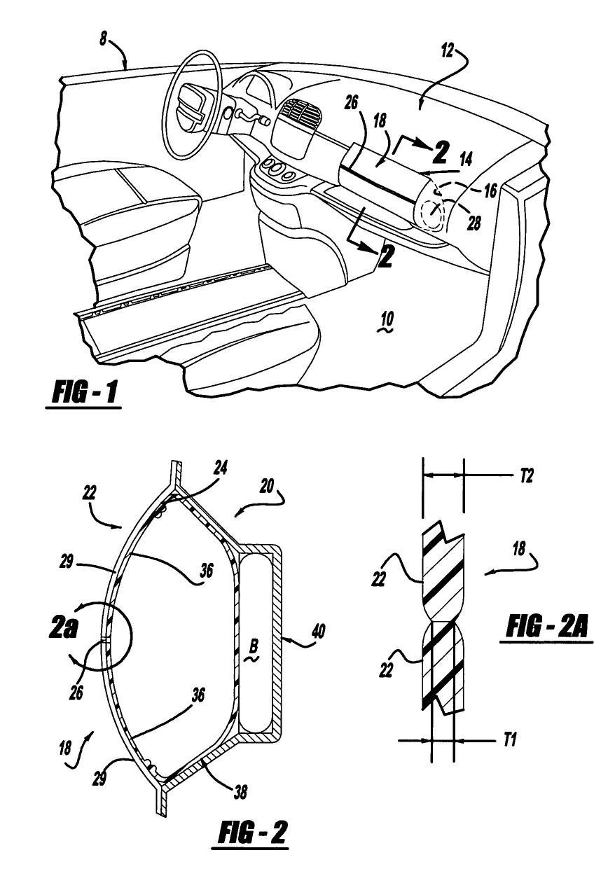

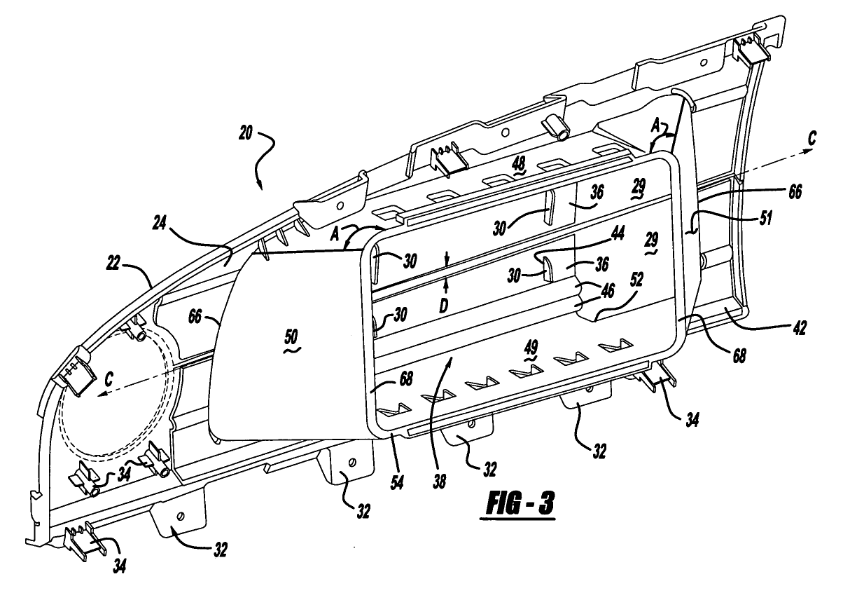

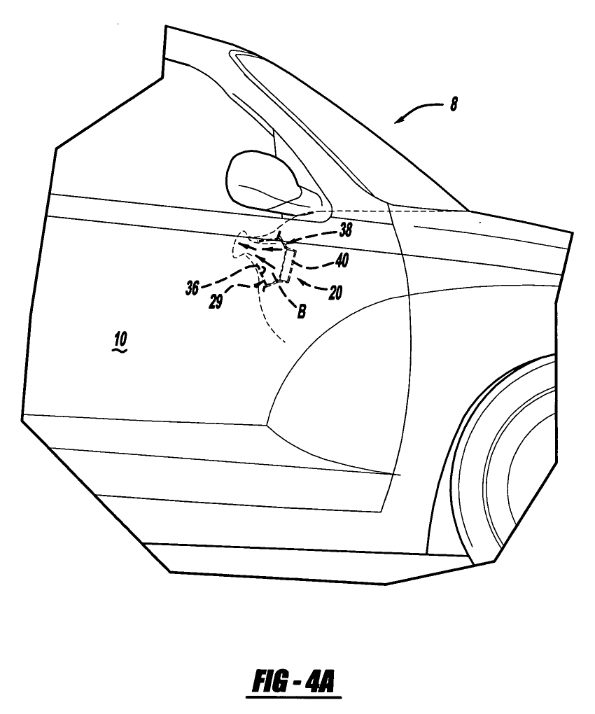

With reference to FIG. 1, a motor vehicle 8 including a passenger area 10 is shown. The passenger area 10 includes an instrument panel 12 which is adapted to receive an air bag system 14. In particular, with continuing reference to FIG. 1, and additional reference to FIGS. 2, 2A and 3, the instrument panel 12 includes an aperture 16 for receipt of the air bag system 14. The air bag system 14 includes an air bag chute cover panel 18 coupled to an air bag chute 20.

Panel 18 includes an outer surface 22 facing passenger area 10, an interior surface 24 and at least one frangible or tearable seam 26. Panel 18 may be formed of any appropriate polymeric material, such as thermoplastic polyolefin (TPO), and may be formed in any shape as desired to coordinate with the instrument panel 12 and the passenger area 10. Cover panel 18 may alternatively include a molded in air vent 28 (shown in phantom) operable to be coupled with the heating and cooling system (not shown) of the motor vehicle 8, to provide the passenger area 10 with pre-heated or cooled air.

Interior surface 24 of panel 18 may include at least one molded feature 30, such as molded protrusions, operable to couple the air bag chute 20 to panel 18. Additionally, it will be understood that any appropriate coupling mechanism could be used to fasten interior surface 24 to the air bag chute 20 such as, for example, adhesives, mechanical fasteners, or in the alternative, the instrument panel interface 18 could be integrally formed with air bag chute 20.

In addition, interior surface 24 may define a plurality of flanges 32 operable to couple panel 18 to a surface of vehicle 8. Further, the second surface 24 may include projections 34 to couple the second surface 24 to the instrument panel 12. It should be noted, however, that any appropriate mechanism could be employed to couple the second surface 24 to the instrument panel 12 and motor vehicle 8.

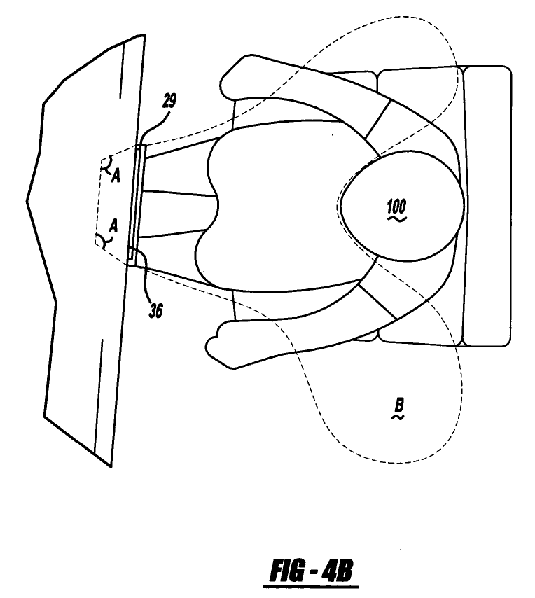

The at least one seam 26 may be generally formed along the centerline C of panel 18, however, the seam 26 may be formed at any desirable location on panel 18, or in the alternative, the seam 26 may include additional horizontal and vertical elements (not shown). The seam 26 further serves to divide panel 18 into two doors 29, however, depending on the seam 26, the doors 29 may be in various shapes and quantities. The seam 26 is generally integrally formed with panel 18, and typically seam 26 is formed by molding a pre-selected area of panel 18 with a reduced thickness T1 as compared to a thickness T2 of panel 18 (as best shown in FIG. 2A). Thus, the reduced thickness T1 enables the seam 26 to fracture to enable an air bag B (as shown in FIG. 4A) to enter the passenger area 10 via chute 20 as will be described in greater detail below.

The air bag chute 20 includes at least one door 36 coupled to a compartment 38, in turn coupled to an air bag module 40. A flange 42 (FIG. 3) couples air bag chute 20 to interior surface 24 of panel 18. The at least one door 36 (two doors 36 shown) may be integrally formed with the compartment 38 or may, in the alternative, be integrally formed with panel 18.

The number of doors 36 is determined by the configuration of seam 26 of panel 18, in particular, seam 26 serves to separate the instrument panel interface 18 into the two doors 29 which correspond to the doors 36. The doors 36 are generally spaced apart along the centerline C of panel 18 to enable the air bag B to expand into the passenger area 10 after it has initially expanded into compartment 38, as will be discussed in greater detail below. The doors 36 further include at least one aperture 44 for receipt of a protrusion 30 extending from inner surface 24 to couple doors 36 to inner surface 24 of panel 18. However any appropriate alternative technique could be used to couple doors 36 to panel 18. Doors 36 may be integrally formed about their outer periphery with compartment 38 and may include at least one flex rib 46, thereby enabling doors 36 to flex outwardly to enable air bag B to expand into passenger area 10.

The compartment 38 includes top and bottom walls 48 and 49, respectively, coupled together via end walls 50 and 51. Compartment 38 is formed such that end walls 50 and 51 diverge outwardly from each other as they extend from a rear aperture defined by rear edge 68 to front 66 of compartment 38. One suitable configuration has a top view cross section of compartment 38 forming an isosceles trapezoid as shown in FIG. 2. The top and bottom 48, 49, of compartment 38 are generally parallel to each other and approximately perpendicular to the end walls 50, 51. Generally, the base angle A at which end walls 50, 51 diverge from rear side 68 can be between 91 and 180 degrees, but is more preferably within 95-128 degrees.

Base angle A of compartment 38 enables air bag B to enter the chute via the rear aperture and then preliminarily expand at least partially parallel to seam 26 within compartment 38 to a greater surface area prior to exiting panel 18. Specifically, the greater the base angle A, the greater the area for the air bag B to expand, and this increase in surface area serves to more evenly distribute the force of the air bag B along seam 26 as it exits compartment 38 at panel 18, while increasing a region in the passenger area 10 which is protected by the air bag B (as best shown in FIG. 4A). Thus, the base angle A can be tuned to any desired angle, depending upon the vehicle, to increase the surface area of coverage and evenly distribute the force of the air bag B on deployment. Base angle A may be different at each end wall 50, 51 in order to direct the air bag B into a desired expansion path for a given vehicle application.

A distance D separates doors 36 and generally corresponds with thickness T1 of seam 26 in panel 18.

As the air bag deploys, it will spread throughout the compartment 38, and apply a substantially uniform force against seam 26. The force will cause the doors 36 to flex outwardly, and simultaneously cause seam 26 to rupture, as shown in FIG. 4A. Once seam 26 fractures, doors 29 of panel 18 will flex outwardly to enable air bag B to expand into passenger area 10 and surround a passenger 100, as illustrated in FIG. 4B.

Base angle A formed in compartment 38 of air bag chute 20 provides air bag B with a greater surface area within which to preliminarily expand in compartment 38 and also serves to more evenly distribute the force of the air bag B over a greater surface area. This even distribution of the expansion force reduces the force of air bag B as it exits compartment 38, thereby protecting passengers which may be seated close to panel 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An air bag chute comprising:
a compartment having a front cover panel including at least one frangible seam therein, a rear aperture opposite the front cover panel adapted to receive a deploying air bag, and first and second walls extending between the rear aperture and the front cover panel, at least one of the walls extending laterally outwardly from the rear aperture toward the front cover panel, whereby the compartment is adapted to enable a deploying air bag to expand at least partially parallel to the frangible seam before contacting the front cover panel.

2. The air bag chute of claim 1 wherein both the first and second walls extend from the rear aperture at substantially equal obtuse angles.

3. The air bag chute of claim 2 wherein the obtuse angles are between about 90° and about 180°.

4. The air bag chute of claim 2 wherein the obtuse angles are between about 95° and about 128°.

5. The air bag chute of claim 1 wherein the front cover panel includes a frangible seam extending substantially along a centerline of the front cover between the first and second walls.

6. An air bag deployment system comprising an air bag chute positioned adjacent an air bag module, the chute comprising a compartment having a front cover panel including at least one frangible seam therein, a rear aperture facing the air bag module for receipt of an air bag deployed from the air bag module, and first and second walls extending between the rear aperture and the front cover panel, at least one of the walls extending laterally outwardly from the rear aperture toward the front cover panel, whereby the compartment enables the deployed air bag entering the rear aperture to expand at least partially parallel to the frangible seam before contacting the front cover panel.

7. An automotive vehicle comprising:
an interior passenger cabin panel having a first side facing the interior passenger cabin and a second side facing away from the interior passenger cabin; and
an air bag deployment system including an air bag chute adjacent the second side of the interior passenger cabin panel and adjacent to an air bag module;
the air bag chute comprising a compartment having a front cover panel positioned in an aperture in the interior passenger cabin panel and including at least one frangible seam therein, a rear aperture facing the air bag module for receipt of an air bag deployed from the air bag module, and first and second walls extending between the rear aperture and the front cover panel, at least one of the walls extending laterally outwardly from the rear aperture toward the front cover panel, whereby the compartment enables the deployed air bag entering the rear aperture to expand at least partially parallel to the frangible seam before contacting the front cover panel.
